(19) United States
(12) Patent Application Publication
(10) Pub. No.: US 2011/0016119 A1
(43) Pub. Date: Jan. 20, 2011

(54) SYSTEM AND METHOD FOR MANAGING USER PROFILES

(75) Inventors: Muralidharan Kodialam, Marlboro, NJ (US); Tirunell Lakshman, Morganville, NJ (US); Sarit Mukherjee, Marlboro, NJ (US); Limin Wang, Plainsboro, NJ (US)

Correspondence Address: HARNESS, DICKEY & PIERCE, P.L.C., P.O. BOX 8910, RESTON, VA, 20195, US

(73) Assignee: Alcatel-Lucent USA Inc.

(21) Appl. No.: 12/503,257

(22) Filed: Jul. 15, 2009

(51) Int. Cl. G06F 17/30

(52) U.S. Cl. 707/733

(57) ABSTRACT

The present invention relates to a system and method for managing user profiles based on keyword content associated with a user. The user associated keyword content represents a website requested by the user or video data viewed by the user, in which the user profile is created and maintained at the customer premise equipment as opposed to the network infrastructure associated with the service provider. For example, the system includes a customer premise equipment (CPE) configured to create a user profile. The user profile includes at least one keyword representing keyword content associated with the user and at least one score representing importance of a corresponding keyword.

### BACKGROUND

Effective targeting of content (e.g., ads) to web users is a major revenue generating service. In order to make such service effective, a service provider must have access to an interest profile of a user. Usually, a service provider creates and maintains user profiles as the users browse different websites, and stores the user profiles in a server within an infrastructure of the service provider. In other words, the service provider has full knowledge of and complete access to the activities and interests of the users.

Conventional methods for creating user profiles based on web browsing activities are either cookie-based tracking or deep packet inspection (DPI). In cookie based tracking, browsing activities of users are tracked by the service provider from a cookie that the browser transmits to the web server. In a DPI based method, the traffic leaving the premise (e.g., home) of the users is inspected by the network to examine which websites the users are visiting. According to both conventional methods, the user profiles are maintained by the service provider within its infrastructure. Although the provider may allow the user to opt-in for profiling or to view and/or modify a user profile, the user does not have explicit control over the user profile and the user profile does not remain with the user. As a result, user's privacy may be comprised.

### SUMMARY

The present invention relates to a method and system for managing user profiles based on keyword content associated with a user, in which the user profile is created and maintained at the customer premise equipment as opposed to the network infrastructure associated with the service provider. As a result, the user has more control over the user profile and the service provider cannot access the user profile without the user's knowledge and cannot independently construct the user profile.

The system includes a customer premise equipment (CPE) configured to create a user profile. The user profile includes at least one keyword representing the keyword content associated with the user and at least one score representing importance of a corresponding keyword. The CPE is configured to create the user profile such that a service provider cannot independently construct the user profile. The CPE may be configured to assign the at least one keyword.

According to one embodiment, the user associated keyword content represents a website requested by the user. According to this embodiment, the CPE is configured to compute the corresponding score for the at least one keyword based on a number of visits to the user requested website. Also, the CPE is configured to incorporate user input parameters into the user profile and assign a score based on the user input parameters.

According to another embodiment, the user associated keyword content represents video data viewed by the user. According to this embodiment, the CPE is configured to consult an electronic program guide (EPG), and map channel surfing information to the EPG to determine which video data the user views. Also, the CPE is configured to compute the corresponding score based on frequency and duration of the viewed video data.

According to an embodiment, the CPE is configured to encrypt the user profile. A key for the encryption may be stored in a CPE different from the CPE containing the user profile.

The present invention also relates to a system for managing user profiles based on keyword content associated with a user. The system includes a keyword database service (KDS) configured to periodically receive a first request from the CPE for creating a user profile at the CPE. The user profile includes at least one keyword representing keyword content associated with the user and at least one score representing importance of a corresponding keyword.

According to one embodiment, the KDS is configured to assign a plurality of first keywords to a first set of keyword content in response to the periodic first request from the CPE. Also, the KDS is configured to assign a plurality of second keywords to a second set of keyword content in response to a second request from the CPE when the CPE does not have a keyword for the user associated keyword content. The second set of keyword content includes the user associated keyword content and other keyword content different from the user associated keyword content.

According to another embodiment, the KDS is configured to receive a request from an anonymous CPE for creating a user profile at the CPE. The KDS is configured to assign the at least one keyword in response to the request from the anonymous CPE.

According to an embodiment, the system may further include a network address translator (NAT configured to anonymize the CPE making the request to the KDS to assign the at least one keyword. The NAT is associated with the service provider. The KDS is not provided with an IP address of the CPE making the request to assign the at least one keyword. Also, the NAT is configured to receive the IP address of the CPE and assign a different IP address from the IP address of the CPE, where the NAT is not provided with the user associated keyword content.

According to another embodiment, the system may include a public domain anonymizer configured to anonymize the CPE making the request to the KDS to assign the at least one keyword. The public domain anonymizer is remote from the service provider and the CPE. The KDS is not provided with an IP address of the CPE making the request to assign the at least one keyword.

Example embodiments also relate to a method for managing user profiles based on keyword content associated with a user. The method includes creating a user profile, by the CPE. The user profile includes at least one keyword representing the keyword content associated with the user and at least one score representing importance of a corresponding keyword. The creating step is performed such that a service provider cannot independently construct the user profile. The method may further include assigning, by the CPE, the at least one keyword.

In one embodiment, the user associated keyword content represents a website requested by the user. In this embodiment, the method may further include computing, by the CPE, the corresponding score for the at least one keyword based on a number of visits to the user requested website and incorporating, by the CPE, user input parameters into the user profile and assign a score based on the user input parameters.

In other embodiment, the user associated keyword content represents video data viewed by the user. In this embodiment, the method may further include consulting, by the CPE, an electronic program guide (EPG), and map channel surfing information to the EPG to determine which video data the user views, and computing, by the CPE, the corresponding score based on frequency and duration of the viewed video data.

In an embodiment, the method may further include encrypting, by the CPE, the user profile, wherein a key for the encryption is stored in a CPE different from the CPE containing the user profile.

In an embodiment, the method includes periodically receiving, by the KDS, a first request from the CPE for creating a user profile at the CPE. The user profile includes at least one keyword representing keyword content associated with the user and at least one score representing importance of a corresponding keyword. The method may further include assigning, by the KDS, a plurality of first keywords to a first set of keyword content in response to the periodic first request from the CPE.

The method may further include assigning, by the KDS, a plurality of second keywords to a second set of keyword content in response to a second request from the CPE when the CPE does not have a keyword for the user associated keyword content. The second set of keyword content includes the user associated keyword content and other keyword content different from the user associated keyword content.

In an embodiment, the method includes receiving, by the KDS, a request from an anonymous CPE for creating a user profile at the CPE. The user profile includes at least one keyword representing keyword content associated with the user and at least one score representing importance of a corresponding keyword. The method may include assigning, by the KDS, the at least one keyword in response to the request from the anonymous CPE.

In one embodiment, the method may further include anonymizing, by a network address translator (NAT), the CPE making the request to the KDS to assign the at least one keyword. The KDS is not provided with an IP address of the CPE making the request to assign the at least one keyword. In this embodiment, the method may further include receiving the IP address of the CPE and assigning a different IP address from the IP address of the CPE. The NAT is not provided with the user associated keyword content.

In another embodiment, the method may include anonymizing, by a public domain anonymizer the CPE making the request to the KDS to assign the at least one keyword. The KDS is not provided with an IP address of the CPE making the request to assign the at least one keyword.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the present invention, and wherein:

FIG. 1 illustrates a system for providing broadband and video services to households according to an embodiment of the present invention;

FIG. 2 illustrates a system for assigning keywords by the KDS to websites based on randomization according to an embodiment of the present invention;

FIG. 3 illustrates a system for assigning keywords by the KDS to websites based on an anonymizer provided by the service provider according to an embodiment of the present invention; and

FIG. 4 illustrates a system for assigning keywords by the KDS to websites based on a public domain anonymizer according to an embodiment of the present invention.

### DETAILED DESCRIPTION OF EXAMPLE EMBODIMENTS

Various example embodiments of the present invention will now be described more fully with reference to the accompanying drawings in which some example embodiments of the invention are shown. Like numbers refer to like elements throughout the description of the figures.

As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Example embodiments of the present invention relate to a system and method for managing user profiles based on keyword content associated with a user. The user associated keyword content may represent any type of internet activities performed by a user such as a website requested by the user. Also, the user associated keyword content represents any activities performed by a mobile phone when connected to a home router using WiFi connection or any similar IP connections. In addition, the user associated keyword content may include any type of video data viewed or requested by a user such as video-on-demand programs requested by the user and/or television programs viewed by the user, for example.

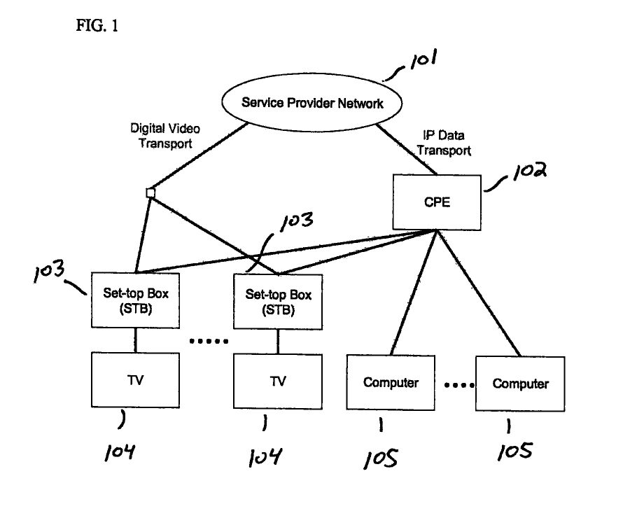

FIG. 1 illustrates a system for providing broadband and video services to households according to an embodiment of the present invention. The system includes a service provider network 101, which provides video services (e.g., cable television) through a digital video transport side of the service provider network 101 to a set-top box (STB) 103 and internet services (e.g., IP connectivity) through an IP data transport side of the service provider network 101 to a customer premise equipment (CPE) 102. The STP 103 is connected to a television 104 and the CPE 102 which is connected to a computer 105, for example. The CPE 102 is commonly known as a home router or a residential gateway. However, video services such as IPTV may be also transported over the IP data transport side of the service provider network 101 via the CPE 102 to the STB 103. In other words, the CPE 102 may also provide IP connectivity to the STB 103. In addition, even without IPTV services, the STB 103 may also include IP connectivity to the service provider network 101 via the CPE 102. For instance, if a household subscribes to both broadband and video services, the STB 103 uses the IP connectivity to download an Electronic Program Guide (EPG), order Pay-per-View events (e.g., Video-on-Demand), view television channels based on video streaming, among others, for example.

Typically, in a household, more than one person views video data and/or browses the internet through a single home router. At least one embodiment of the present invention relates to creation of a household profile. However, because different techniques known in the field may be used to partition the household profile into personality profiles, specific user profiles are within the example embodiments of this invention. For the sake of simplicity, the user and household will refer to the same entity.

The user profile of the household is created based on web browsing activities of the user over the broadband service and video data viewing activities over the video service (including on-demand requests), if both services are active. If only one service is present for the household, the user profile will be based on that service only. Therefore, the example embodiments described below relate to user profiles based on internet activities and/or user profiles based on video data viewing activities.

The CPE 102 creates and maintains a user profile. For instance, the user profile is created and maintained at the CPE 102. Because the CPE 102 is located at the premise of the user, the user profile does not leave the household of the user. Also, because the CPE 102 does not allow pertinent information relating to the web-browsing activities and/or video data viewing activities of the user to be disclosed to the service provider network 101, the service provider has neither knowledge of nor access to the user profile. As a result, the service provider cannot independently construct the user profile, and the user feels more comfortable about having his user profile created.

Furthermore, the user profile does not have to be disclosed to the service provider in order for the service provider to provide targeted advertisements to the user. For instance, instead of the service provider choosing the best advertisement for a user based on his user profile, the service provider transmits to the user a plurality of advertisements, and the CPE 102 is responsible for selecting one or more advertisements that best match the current user profile being maintained at the CPE 102. In other words, the CPE 102 acts as an intermediate “trusted” entity for both the user and the service provider. Periodically, the CPE 102 may send a summary of revenue information to the service provider so that the advertisers can be billed appropriately for the advertisements. By sending a summary, the CPE 102 may hide the actual information about the ads that were shown to the user.

The CPE 102 may be the computer 105 or a Residential Gateway (RG), for example. The RG typically provides broadband services, or dual play services which include both broadband and video services, for example. Because the RG must be activated for any network activity to take place, all household traffic passes through the RG.

The user profile includes at least one keyword and a corresponding score—e.g., a set of pairs. As stated above, the keyword represents keyword content associated with the user, while the score represents the importance of the corresponding keyword, which is based on a website requested by the user and/or the video data viewed by the user. For instance, in regards to web browsing activities, the score may represent the frequency of visits to a particular website. In regards to video data viewing activities, the score may represent the frequency and duration of the viewed video data.

### Profile Creation Based on Web Browsing Activities:

As the user visits different websites, the CPE 102 examines the requests being transmitted to the internet by inspection of network packets using the DPI technique or acting as a transparent web proxy, for example. The CPE 102 collects information about the requested website and any user input parameters (e.g., search terms). The CPE 102 utilizes the information regarding the requested website and the user input parameters to construct a user profile. As stated above, the user profile includes pairs of a keyword and its score. Any user input parameters can be directly incorporated into the profile with a relatively high score. For example, if a user visits amazon.com and searches for coffee maker, then it is clear that the user currently is interested in coffee makers and related household goods. While the user input parameters may be easily incorporated into the profile, the requested website, as it is, cannot be part of a profile. Therefore, the CPE 102 has to translate a given website into relevant keywords that best describe the website and compute a relative score to the keywords based on how many times the user visits the website. Two different methods for assigning keywords to websites are discussed below.

CPE-centric. In this method, the CPE 102 assigns keywords to websites. For example, as part of the response for the website request, a web server transmits an html page to the user. When the html page passes through the CPE 102, the CPE 102 examines the html page and assigns keywords to the website. Because conventional methods exist for assigning appropriate keywords to websites, the operation for assigning appropriate keywords to websites is omitted for the sake of brevity. The CPE 102 may use one of the conventional methods or any type of new scheme for assigning keywords. Although this method may introduce new workload for the CPE 102, the CPE-centric method does not create additional network traffic or divulge user specific information to the service provider. However, the new workload may be easily handled by current generation CPEs without sacrificing performance for other services.

Service Provider assisted. According to this method, the CPE 102 consults with a service provider's infrastructure resident server, referred to as Keyword Database Server (KDS), to assign keywords to a website. For instance, the CPE 102 securely transmits (e.g., over SSL) the url of the website requested by the user to the KDS which in response returns the keywords assigned to the web page. The KDS may use any existing or new algorithm for assigning keywords to web pages. Because the KDS is a centralized resource, the service provider may apply resource intensive methods (e.g., in terms of computing power or network bandwidth) for assigning keywords to websites, which may not desirable for the CPE-centric method. While the service provider assisted method may reduce the computing load on the CPE 102, the service provider assisted method may introduce a minor load on the network for querying the KDS. However, the query traffic may be assigned low priority so that the querying function does not interfere with the other network traffic.

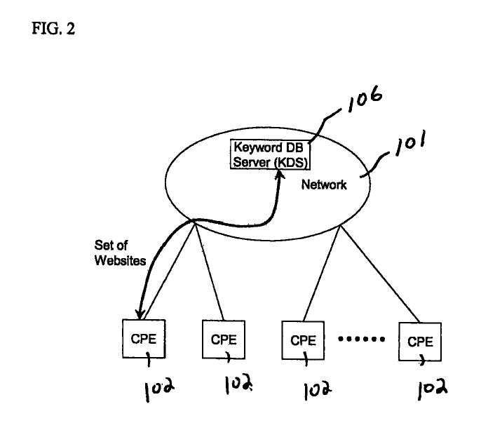

The query function may leak user related information to the service provider by informing the KDS of the websites visited by the user. In order to avoid the information leakage, three different methods are discussed below with reference to FIGS. 2-4. Similar to the CPE-Centric method, all three methods of the service provider assisted method prevent the service provider from independently constructing the user profile being maintained at the CPE. As a result, the user maintains a certain level of privacy.

FIG. 2 illustrates a system for assigning keywords by the KDS to websites based on randomization according to an embodiment of the present invention. The system in FIG. 2 illustrates a network 101 of the service provider with the KDS 106 being located within the network 101 of the service provider but remote from the CPEs 102.

Referring to FIG. 2, the CPE 102 periodically requests the KDS 106 to assign a plurality of keywords to a set of websites. For example, the CPE 102 may be configured to request the KDS 106 to assign the keywords weekly, daily, hourly, or any type of periodic time period. The set of websites may be mixture of most frequently requested websites, least frequently requested websites, websites requested during the last few hours, for example. The CPE 102 caches this information and, therefore, if the user visits any website from this list, the CPE 102 does not have to make a specific request to the KDS 106 to obtain a keyword.

If the user visits a website not on the list, the CPE 102 requests the KDS 106 to assign a plurality of keywords to a set of websites. This set of websites includes the user requested website and other websites different from the user requested website. As a result, because the assignment request includes the user requested website as well as additional websites different from the user requested website, the KDS 106 will not know exactly which website the user has visited. The request to the KDS 106 for keyword assignments is transmitted over an encrypted channel such that no entity other than the KDS 106 in the network 101 of the service provider can view the requested website. According to this method, the KDS 106 or the service provider are not able to obtain the exact websites which the user visited.

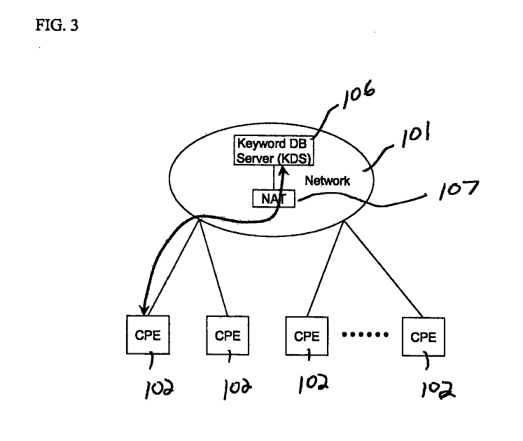

FIG. 3 illustrates a system for assigning keywords by the KDS to websites based on an anonymizer provided by the service provider according to an embodiment of the present invention. The system in FIG. 3 illustrates the network 101 of the service provider with the KDS 106 being located within the network 101 of the service provider but remote from the CPEs 102. The system in FIG. 3 also includes a network address translator (NAT) 107, which is associated with the network 101 of the service provider.

In this embodiment, the KDS 106 assigns a keyword in response to a request from the CPE 102. The request includes information regarding the user requested website. Also, as described above, the request to the KDS 106 for keyword assignments is transmitted over an encrypted channel such that no entity other than the KDS 106 in the network 101 of the service provider can view the requested website.

The NAT 107 anonymizes the CPE 102 making the request to the KDS 106. For example, the NAT 107 receives the IP address of the CPE 102 making the request and assigns an IP address different from the IP address of the CPE 102 making the request. Also, the NAT 107 does not receive any information related to the requested website. As a result, because the NAT 107 changes the IP address of the CPE 102 making the request, the CPE 102 remains anonymous to the KDS 106 despite the fact that the KDS 106 views the information related to the website in order to assign the keyword to the requested website. The KDS 106 sends the response securely back over the SSL session and NAT 107 to the CPE 102. Because the KDS 106 does not view the original IP address of the CPE 102, the KDS 106 does not know which CPE 102 made the request. Therefore, the user profile is not exposed to the service provider. Any additional traffic load into the network 101 is not created other than the requests for the websites that the user actually visits.

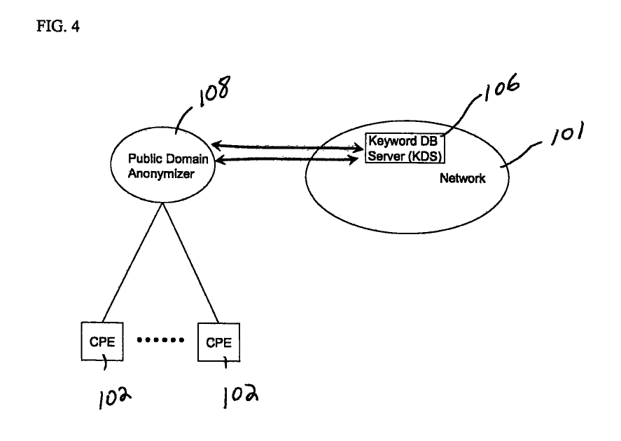

FIG. 4 illustrates a system for assigning keywords by the KDS to websites based on a public domain anonymizer according to an embodiment of the present invention. The system in FIG. 4 illustrates the network 101 of the service provider with the KDS 106 being located within the network 101 of the service provider but remote from the CPEs 102. Also, FIG. 4 illustrates a public domain anonymizer 108, which is remote from the network 101 of the service provider and the CPE 102.

The public domain anonymizer 108 anonymizes the CPE 102 making the request to the KDS 106. As a result, the KDS 106 is not provided with an IP address of the CPE 102 making the request to assign the at least one keyword. Also, the public domain anonymizer 108 is not associated with the network 101 of the service provider.

After the keyword is assigned to the requested website, the CPE 102 computes the corresponding score for the keyword based on the frequency of visits to the website. The frequency of visits to a particular website is not exposed to the service provider, and therefore, it is impossible for the service provider to replicate the user profile.

### Profile Creation Based on Video Data Viewing Activities:

Referring back to FIG. 1, the video data viewing activities of the user (including video-on-demand requests), for example, are processed through the STB 103. As shown in FIG. 1 and discussed earlier, because the STB 103 has IP connectivity to the CPE 102, the STB 103 sends requests related to the video data viewing activities of the user to the CPE 102. In regards to IPTV services, all requests must be passed through the CPE 102. If a particular video service is not configured to pass through the CPE 102, IP connectivity may be added as an additional functionality. However, most dual/triple play service providers (e.g., internet, cable, phone) use the IP connectivity to download the EPG and order Pay-per-View services.

In regards to the video data viewing activities of the user, the CPE 103 is configured to consult the EPG information, and map the channel surfing information to the EPG to decipher the video data the user views. Similar to the system described above with respect to the web browsing activities, the CPE 102 creates and maintains a user profile at the CPE 102. As stated above, the user profile for video data viewing activities includes at least one keyword representing video data viewed by the user and at least one score representing importance of a corresponding keyword.

The CPE 102 for video data viewing activities operates in a similar manner described above with reference to the web browsing activities. For example, the CPE 102 assigns a keyword for viewed video data and computes the corresponding score based on frequency and duration of the viewed video data. Because the EPG information remains within the CPE 102, channel surfing activities may not be required to be assigned keywords by the service provider according to the service provider assisted methods described above. However, the CPE 102 may also be configured to operate in a manner described with reference to FIGS. 2-4, which describe the service provider assisted methods.

As stated above, video data viewing activities also include requests for video-on-demand services (i.e., Pay-per-View). Video-on-demand services also pass through the CPE 102. Based on which service and/or movie the user have ordered, the CPE 102 creates the relevant keyword score pair for the profile being maintained at the CPE 102. However, for video on-demand services, because the user may order from a large selection of items, the CPE 102 may not be able to cache all the keywords associated with the large selection of items. As a result, any of the methods described in FIGS. 2-4 may be implemented to assign keywords for the on-demand services.

In all the methods described above with reference to the web browsing and video data viewing activities of the user, the CPE 102 may encrypt the user profile created and maintained in the CPE 102. The profile information in the CPE 102 may be encrypted so that an inadvertent information leakage does not reveal any user pertinent information to the service provider. Furthermore, the key for encryption may be stored in the personal computer of the user in order to give the user more control over the user profile. For additional protection, the user profile may be encrypted and the key may be stored in a CPE 102 different from the CPE storing the user profile.

Example embodiments of the present invention being thus described, it will be obvious that the same may be varied in many ways. Such variations are not to be regarded as a departure from the spirit and scope of the exemplary embodiments of the invention, and all such modifications as would be obvious to one skilled in the art are intended to be included within the scope of the invention.

What is claimed is:

1. A system for managing user profiles based on keyword content associated with a user, the system comprising:
a customer premise equipment (CPE) configured to create a user profile, the user profile including at least one keyword representing the keyword content associated with the user and at least one score representing importance of a corresponding keyword.

2. The system of claim 1, wherein the CPE is configured to create the user profile such that a service provider cannot independently construct the user profile.

3. The system of claim 1, wherein the CPE is configured to assign the at least one keyword.

4. The system of claim 1, wherein the user associated keyword content represents a website requested by the user.

5. The system of claim 4, wherein the CPE is configured to compute the corresponding score for the at least one keyword based on a number of visits to the user requested website.

6. The system of claim 4, wherein the CPE is configured to incorporate user input parameters into the user profile and assign a score based on the user input parameters.

7. The system of claim 1, wherein the user associated keyword content represents video data viewed by the user.

8. The system of claim 7, wherein the CPE is configured to consult an electronic program guide (EPG), and map channel surfing information to the EPG to determine which video data the user views.

9. The system of claim 7, wherein the CPE is configured to compute the corresponding score based on frequency and duration of the viewed video data.

10. The system of claim 1, wherein the CPE is configured to encrypt the user profile, wherein a key for the encryption is stored in a CPE different from the CPE containing the user profile.

11. A system for managing user profiles based on keyword content associated with a user, the system comprising:
a keyword database service (KDS) configured to periodically receive a first request from a customer premise equipment (CPE) for creating a user profile at the CPE, the user profile including at least one keyword representing keyword content associated with the user and at least one score representing importance of a corresponding keyword,
the KDS being configured to assign a plurality of first keywords to a first set of keyword content in response to the periodic first request from the CPE.

12. The system of claim 11, wherein the KDS is configured to assign a plurality of second keywords to a second set of keyword content in response to a second request from the CPE when the CPE does not have a keyword for the user associated keyword content, the second set of keyword content including the user associated keyword content and other keyword content different from the user associated keyword content.

13. The system of claim 11, wherein the user associated keyword content represents a website requested by the user.

14. The system of claim 11, wherein the user associated keyword content represents video data viewed by the user.

15. A system for managing user profiles based on keyword content associated with a user, the system comprising:
a keyword database service (KDS) configured to receive a request from an anonymous customer premise equipment (CPE) for creating a user profile at the CPE, the user profile including at least one keyword representing keyword content associated with the user and at least one score representing importance of a corresponding keyword,
the KDS being configured to assign the at least one keyword in response to the request from the anonymous CPE.

16. The system of claim 15 further comprising:
a network address translator (NAT) configured to anonymize the CPE making the request to the KDS to assign the at least one keyword, the NAT being associated with the service provider, wherein the KDS is not provided with an IP address of the CPE making the request to assign the at least one keyword.

17. The system of claim 16, wherein the NAT is configured to receive the IP address of the CPE and assign a different IP address from the IP address of the CPE, wherein the NAT is not provided with the user associated keyword content.

18. The system of claim 15, further comprising:
a public domain anonymizer configured to anonymize the CPE making the request to the KDS to assign the at least one keyword, the public domain anonymizer being remote from the service provider and the CPE, wherein the KDS is not provided with an IP address of the CPE making the request to assign the at least one keyword.

19. The system of claim 15, wherein the user associated keyword content represents a website requested by the user.

20. The system of claim 15, wherein the user associated keyword content represents video data viewed by the user.

21. A method for managing user profiles based on keyword content associated with a user, the method comprising:
creating a user profile, by a customer premise equipment (CPE), the user profile including at least one keyword representing the keyword content associated with the user and at least one score representing importance of a corresponding keyword.

22. The method of claim 21, wherein the creating step is performed such that a service provider cannot independently construct the user profile.

23. The method of claim 21, further comprising:
assigning, by the CPE, the at least one keyword.

24. The method of claim 21, wherein the user associated keyword content represents a website requested by the user.

25. The method of claim 24, further comprising:
computing, by the CPE, the corresponding score for the at least one keyword based on a number of visits to the user requested website.

26. The method of claim 24, further comprising:
incorporating, by the CPE, user input parameters into the user profile and assign a score based on the user input parameters.

27. The method of claim 21, wherein the user associated keyword content represents video data viewed by the user.

28. The method of claim 27, further comprising:
consulting, by the CPE, an electronic program guide (EPG), and map channel surfing information to the EPG to determine which video data the user views.

29. The method of claim 27, further comprising:
computing, by the CPE, the corresponding score based on frequency and duration of the viewed video data.

30. The method of claim 21, further comprising:
encrypting, by the CPE, the user profile, wherein a key for the encryption is stored in a CPE different from the CPE containing the user profile.

31. A method for managing user profiles based on keyword content associated with a user, the method comprising:
periodically receiving, by a keyword database service (KDS), a first request from a customer premise equipment (CPE) for creating a user profile at the CPE, the user profile including at least one keyword representing keyword content associated with the user and at least one score representing importance of a corresponding keyword,
assigning, by the KDS, a plurality of first keywords to a first set of keyword content in response to the periodic first request from the CPE.

32. The method of claim 31, further comprising:
assigning, by the KDS, a plurality of second keywords to a second set of keyword content in response to a second request from the CPE when the CPE does not have a keyword for the user associated keyword content, the second set of keyword content including the user associated keyword content and other keyword content different from the user associated keyword content.

33. The method of claim 31, wherein the user associated keyword content represents a website requested by the user.

34. The method of claim 31, wherein the user associated keyword content represents video data viewed by the user.

35. A method for managing user profiles based on keyword content associated with a user, the method comprising:
receiving, by a keyword database service (KDS), a request from an anonymous customer premise equipment (CPE) for creating a user profile at the CPE, the user profile including at least one keyword representing keyword content associated with the user and at least one score representing importance of a corresponding keyword,
assigning, by the KDS, the at least one keyword in response to the request from the anonymous CPE.

36. The method of claim 35 further comprising:
anonymizing, by a network address translator (NAT), the CPE making the request to the KDS to assign the at least one keyword, wherein the KDS is not provided with an IP address of the CPE making the request to assign the at least one keyword.

37. The method of claim 36, further comprising:
receiving the IP address of the CPE and assigning a different IP address from the IP address of the CPE, wherein the NAT is not provided with the user associated keyword content.

38. The method of claim 35, further comprising:
anonymizing, by a public domain anonymizer the CPE making the request to the KDS to assign the at least one keyword, wherein the KDS is not provided with an IP address of the CPE making the request to assign the at least one keyword.

39. The method of claim 35, wherein the user associated keyword content represents a website requested by the user.

40. The system of claim 35, wherein the user associated keyword content represents video data viewed by the user.
